(19) United States
(12) Patent Application Publication
(10) Pub. No.: US 2013/0103537 A1
(43) Pub. Date: Apr. 25, 2013

(54) INTERACTIVE CONSUMER SELF-SERVICE SHOPPING SYSTEM

(71) Applicant: Spencer Thornton Hewett, Palo Alto, CA (US)

(72) Inventor: Spencer Thornton Hewett, Palo Alto, CA (US)

(21) Appl. No.: 13/651,297

(22) Filed: Oct. 12, 2012

Related U.S. Application Data
(60) Provisional application No. 61/547,660, filed on Oct. 14, 2011.
(60) Provisional application No. 61/662,526, filed on Jun. 21, 2012.

(51) Int. Cl. G06Q 30/06

(52) U.S. Cl. CPC G06Q 30/0633
USPC 705/26.7; 705/26.8

(57) ABSTRACT

A system for electronic self-service shopping includes a server and modules for interacting with a shopper's mobile device. The server interacts with a merchant's store system to provide information about products within a store. Alternatively, the server interacts with a merchant enterprise system, which contains information about multiple stores, to provide information about products within a particular store. A virtual shopping cart allows a shopper to select products and then purchase them electronically. After the items in the virtual shopping cart are purchased, the store's security system is notified of the items that have recently been purchased to allow the shopper to exit the store with the items.

### BACKGROUND

As demand for consumer goods grows and urbanization increases so does the wait in checkout lines. As the size of retail stores grows and there are more and more products offered, locating a specific item is cumbersome and tedious. The different layout schemes of stores and merchant establishments often leads to a time consuming search to find the one product a consumer is looking for. Often stores require consumers wait in lines or queues to return items or ask questions at the customer service desks in stores.

It is well known in the art to utilize electronic devices, such as smartcards or smartphones to assist in the shopping experience. For example, it is possible to pay for items using an, application installed on a mobile computing device, such as a smartphone, which corresponds to a stored value card. However, the prior art is limited in that it often merely mimics a credit, debit or stored value card, which allows for final payment of an item or items being purchased.

A prime example of the current state of the art is an application designed for the iOS operating system used with iPhones which allows for the payment of items purchased at Starbucks Coffee Company. The application displays a computer readable code that is linked to the user's account, which is a stored value account corresponding to a physical stored value card.

Such applications are severely limited in their usefulness as they can only be used for payment. It would be desirable to have more functionality associate with such applications which allow expanded functionality for a customer shopping in a brick and mortar store.

### SUMMARY OF THE INVENTION

The system and application of embodiments of the present invention thereof allows the use of a mobile device to assist with a variety of functions when shopping. The mobile computing device serving as a platform for the invention preferably has a user interface consisting of a screen capable of displaying graphics and video, a camera capable of scanning and reading bar and QR type codes, a means of connecting to a network, such as WiFi, 3G, LTE, a GPS receiver or other means of location detection, and an application implementing the functions of the present invention. An iPhone or other iOS device is an acceptable platform for this invention.

An embodiment of the invention described is a system which partially runs on the user's mobile computing device and partially on system servers. It interacts with a merchant's online and/or brick and mortar store system through a system integration. The system described in this embodiment can be used on location at the merchant site, or off location.

The application allows the user to search for, locate, identify and select an item for sale and additionally allows the user to pay for that item directly from a mobile computing device. The mobile computing device can be identified to the store upon physical entry to the premises via an identifier which may include, inter alia, device ID, user account ID, device IP address, device MAC address, device frequency and phone number.

The item(s) selected for purchase are identified via one of several means, which may include, for example, an item ID, an item location, an item frequency, an item bar or QR code, and an item RF tag.

A specific item maybe associated with a user's mobile computing device and tagged for purchase by identifying the item via any one of several well known methods, including, for example, by bring the item and mobile computing device in close proximity to one another, via reading a bar or QR code, by reading an NFC transmission, by sensing an RF tag on the item, via BlueTooth, or via any other means known or later developed.

When an item is associated with the user's mobile computing device, it is placed into a virtual shopping cart for purchase. The physical item may also be placed into a physical cart as one would do at a grocery store, for example, or may be marked for later delivery to the user.

When the user has completed the shopping experience, the items in the virtual cart may be paid for by the user by explicitly signaling to the mobile computing device to process the payment, or may happen automatically by bring the mobile computing device in close proximity to a pay station. Preferably, the mobile computing device is also associated with an account to be used for payment, for example, a bank account, a credit card account, or an account specific to the merchant. The consumer would then be able to pay for the item using any form of electronic payment.

Once paid for, the items and the buyer (via their consumer electronic device/account) would be cleared by a detection mechanism (e.g. RFID or NFC or GPS, or WiFi triangulation, etc. or any combination thereof) and the store security system to exit with the items which have been purchased.

### DESCRIPTION OF THE DRAWINGS

FIG. 1 is a flow chart showing the use of an embodiment of the present invention for a typical shopping experience.

FIG. 2 is a system architecture diagram, showing a first exemplary system which may be used to implement an embodiment of the present invention.

FIG. 3 is a system architecture diagram, showing a second exemplary system which may be used to implement an embodiment of the present invention.

### DETAILED DESCRIPTION

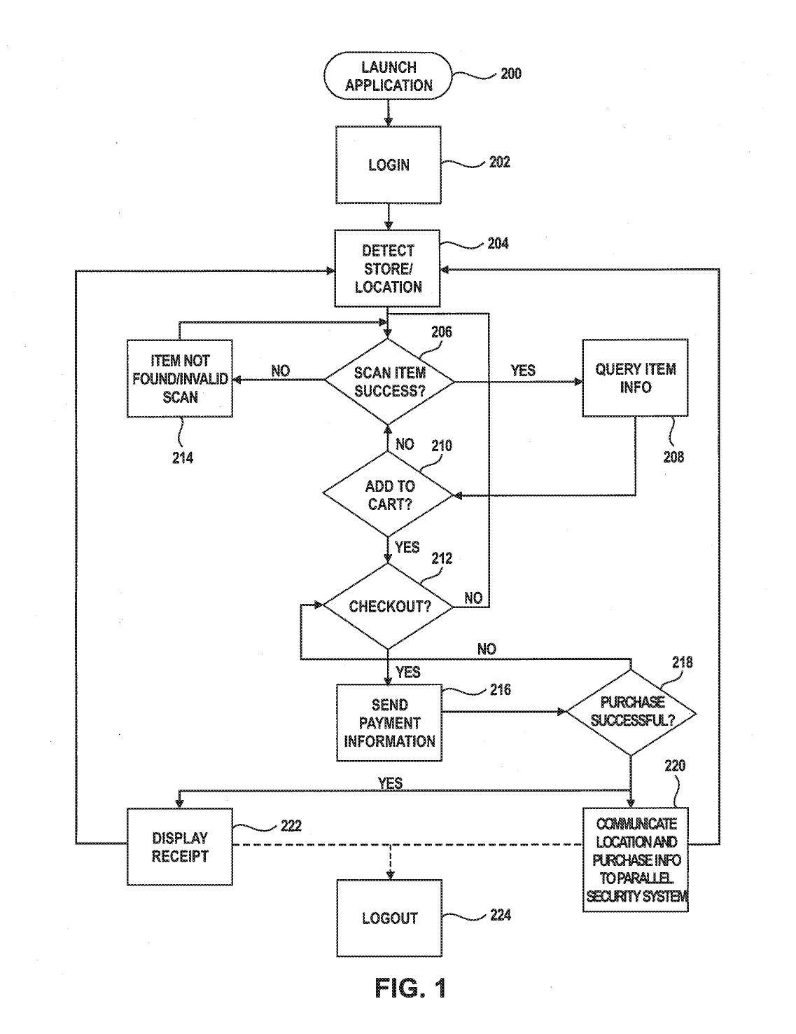

FIG. 1 is a flow chart showing a method of using an embodiment of the present invention. It should be noted that the process shown in FIG. 1 is exemplary only in nature and many variations on the process are possible. Only the basic features of an embodiment of the invention are shown in FIG. 1. Alternate embodiments expressing additional features are explained below but are not shown in the drawings.

In step 200, the user launches the application. The application may be a general application in which the user must identify the particular merchant once inside the application or may be an application specific to a particular merchant. Alternatively, the particular merchant may be detected automatically (see step 204 below) through a geolocation service, such as a GPS receiver built in to the mobile computing platform.

In step 202, the user provides login information. In alternate embodiments, the login information may be for a central server having information on all merchants that the present invention is capable of being used with, or may be login information specific to a particular merchant.

In step 204, the particular store or location where the user is shopping is identified. This may happen via any one of a well known means of performing geolocation on a mobile computing platform including reception of GPS signals, via Wi-Fi triangulation, or by geofencing. This may be performed in a number of ways, including but not limited to receiving the store or location information upon connecting to the store Wi-Fi or transmitting a signal to a mobile device on a frequency inaudible to the human ear.

In step 206, a user has identified a specific item of interest and selects said item. The item is then scanned with the mobile computing platform. The scan may be performed, for example, using a bar code or a QR code associated with the item or by scanning an active or passive RFID tag physically placed on the item, by utilizing some form of NFC communication, or any other means well known in the art. Alternatively, the item may be scanned by reading a transponder ID for the RFID tag, and correlating the transponder ID with a bar code (UPC code) or QR code associated with the item, for example such a code stored in the merchant's computer system, or another computer system. If the item is scanned successfully, that is, the means of identification is successful and the item is able to be identified thereby, processing proceeds to step 208 where information regarding the item, such as manufacturer, price, quantity, nutritional information, etc. may be displayed. Step 208 is an optional step. The user may simply wish to place the item directly into his virtual shopping cart.

If the item is able to be successfully scanned in step 206, or if the item is not found or there is an invalid scan, processing proceeds to step 214, and the control returns to step 206 where the user may scan another item or attempt a second scan at the failed item.

Once user has successfully scanned the item, the information necessary to either purchase the item or information about the item to be displayed is obtained either from the merchant's computers or from a central server servicing multiple merchants.

In step 210, the user decides whether to purchase the item. If the user decides not to purchase the item, control is returned to step 206 where another item may be scanned. If the user decides that the item is to be purchased, the item is placed in the user's virtual cart and, at step 212, the user has the opportunity to check out. If the user is not ready to check out, control is returned to step 206 for the scanning of additional items. If the user wishes to check out, control is sent to step 216 where payment information is retrieved and processed.

In step 218, it is determined if the purchase was successful, that is, for example, payment from a particular account specified by the user has been approved. If not, control is returned to step 212 where the user may check out utilizing a different means and sending different payment information in step 216. If the purchase is successful, control is sent to step 220 where the items purchased are cleared through the store's security system, either via the merchant's local computers or through a central server servicing multiple merchants.

In step 222, a receipt for the purchased items is displayed in parallel with the clearing of the items in step 220. After the items are cleared, the user may log out of the system at step 224 or may proceed to a different store at step 204 where the process starts over.

Many variations on the processing exist and many details of implementation are possible, some of which are explained below. In step 206, where items are scanned, as an alternate to scanning the item, it may also be possible to provide automated detection by bringing the item in close physical proximity with the user's mobile computing device. This mechanism typically involves activating an RFID tag on the item to be purchased or detecting the item via a near field or BlueTooth communication. Preferably, the user's mobile computing device is used to activate the mean of identification, however, it is also possible that the merchant will provide a means of activating the identification of the product, for example, a hand-held scanner. In an alternative embodiment of the invention, the system may be implemented without the ability to identify the items being purchased via an active or passive product identification system.

In a separate embodiment of the invention, once an item has been scanned in step 206, it is possible to add the item to a “wish list” maintained by the user for future purchase or for notification of when the product is, for example, placed on sale by the merchant.

Once the item is scanned in step 206, the merchant's inventory system or product information system may be queried in step 208. Alternatively, the system may read the item's detailed information directly from the product ID tag, without reference to an inventory control system.

In another embodiment of the invention, the consumer may store coupons in the system and may apply coupons or other promotional offers to purchases of items in the cart. Likewise, the user may be permitted to apply loyalty or rewards points to the purchase or to gain benefits, such as discounts via the merchants loyalty program. Information regarding the user's loyalty account with the merchant may be pre-entered or may be obtained via scanning a membership card with the mobile computing device.

In yet another embodiment of the invention, the application allows users to view a map of the products available in the store or allows users to search for a particular item by entering its description or name on the mobile computing platform and having the system return the location of the item in the merchant's store. In a variation of this feature, the system may be able to show the consumer, in addition to the location of the product in the store, the number of items of the product available or other information specific to the product similar to the information that may be displayed when the product is actually scanned by the user.

In yet another alternate embodiment of the invention, the user is not required to physically place the item into a shopping cart. The items may be purchased by scanning and left on the shelf for later delivery either at another location in the merchant's store or at the user's home via a delivery service.

The proximity of the mobile computing device and the item to be purchased can be based on signal strength and/or latency to detect how close the item is to the mobile computing device. In addition, the system can warn the consumer if an item added to the user's virtual shopping cart is paid for or is missing from the proximity of the mobile computing device. The system can also warn the consumer before exiting the merchant's store if products not to be purchased are present in close proximity to the mobile computing device, for example, items that the user has place on the “wish list”.

In yet another alternative embodiment of the invention, the system may support voice driven input from the user to include the functions of identifying, selecting, searching, locating and inquiring for additional information about items in the store or to make payments for the product.

Another feature of the invention includes the addition of a shopping list which the user may assemble away from the merchant's store. The system may then search items on the shopping list and inform the user of various locations or merchant stores where those items are available. For such a feature, it may be necessary for the user to allow location detection of the mobile computing device and the transmission of that information to a remote system. In an alternative of this feature, once the user reaches the merchant's store, the system may direct the user to the specific areas of the stores where the items on the user's shopping list may be found. This is accomplished by communicating with the merchant's store system which preferably knows the location of all items in the store. This feature can be supported even if the listed items were added from another merchant's catalog or inventory.

The system may also be used to look up a product on a merchant's online catalog. This catalog would show the product details (e.g. color, size, weight, description, fit, material of construction, etc. and availability in a merchant's establishment(s) or a franchise(s) or an authorized store(s) at a location of choice or at a default location calculated by the system. If the user chooses to reserve the item online the system will interact with the store brick and mortar systems to have a store associate reserve the item.

If the user chooses to go to the brick and mortar store the system can show the nearby locations of the merchant's store and can provide details of the item as well as the item availability and the number of items in inventory.

In yet another alternative embodiment, the system can present item suggestions on relevant targeted products to the consumer based upon the user's shopping history, special offers, loyalty credits, interests, location, preferences and other relevant demographic information. The user may also be alerted as to items on sale or alternative item to those in the shopping cart.

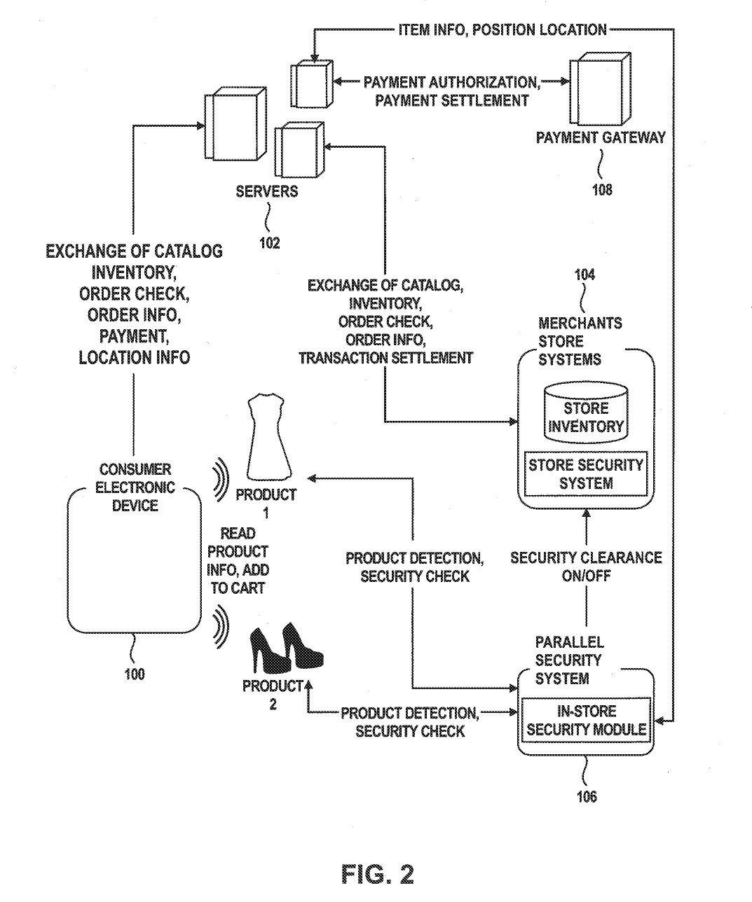

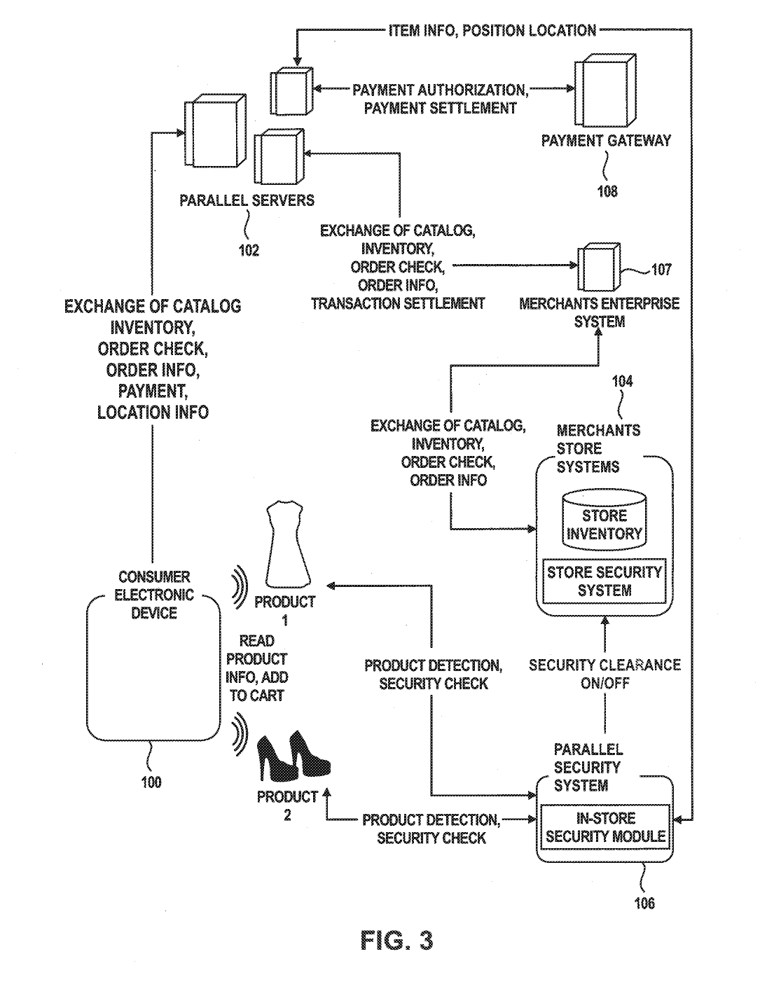

FIGS. 2 and 3 show separate embodiments of the invention and the flow of information between the various components of the invention. FIG. 2 shows an implementation whereby central servers exchange catalog inventory, order information and transaction settlement directly with the merchant's store systems. In the second embodiment of the invention shown in FIG. 3, this information is exchanged with the merchant's enterprise system which in turn interacts with the merchant's store system. In this implementation of the invention, the consumer electronic device or mobile computing device 100 is used to scan products via one of the methods previously mentioned. Information regarding the products is obtained from central servers 102 who in turn obtain that information regarding the products from merchant store systems 104. In addition, information regarding inventory and location of the items is also obtained from merchant store 104. Security is enforced via in-store security module 106 in cooperation with a central security system. Such a system is able to detect products and perform security checks to insure that products are paid for before they leave the merchant's premises. Payments are authorized and settled via payment gateway 108 through central servers 102. The merchant's store systems 104 maintain the store inventory and security for the items in the store. When items leave the store after being paid for via payment gateway 108, the store's inventory is adjusted accordingly.

FIG. 3 shows an alternate system wherein the central server 102 interacts with a merchant enterprise system 107. Merchant's enterprise system 107 interacts with multiple store systems 104.

While several embodiments of the invention have been discussed, one of ordinary skill in the art would recognize that the actual implementations of those systems may vary without deviating from the scope or spirit of the invention. For example, the system is shown interacting with central servers 102 in FIGS. 2 and 3, however, the system may be implemented as an entirely in-store module without interfacing with external servers, although many of the unique features of embodiments of the invention are provided through the interface with the central server. In any case, the embodiments shown are exemplary in nature and may vary with implementation details.

I claim:

1. A method for purchasing a product in a physical store, comprising the steps of:
receiving at a server a selection signal, sent from a mobile device, that corresponds to a selected product;
placing into a virtual shopping cart a virtual product that corresponds to the selected product;
receiving at the server a payment signal from the mobile device;
processing a payment; and
sending a security signal that identifies the selected product to a security system.

2. The method of claim 1 further comprising the step of the server sending to the mobile device a product description signal that allows the mobile device to display information about a product.

3. The method of claim 1 further comprising the step of the server sending to the mobile device a receipt signal that allows the mobile device to display a receipt.

4. The method of claim 1 further comprising the step of receiving at the server a coupon signal sent from the mobile device.

5. The method of claim 1 further comprising the step of the server sending to the mobile device a map signal that allows the mobile device to display the location of one or more products of interest.

6. The method of claim 5 further comprising the steps of the server receiving a product location request signal from the mobile device and selecting the one or more products of interest using the product location request signal.

7. The method of claim 1 further comprising the step of the server sending to the mobile device a suggested product signal that allows the mobile device to display information about a suggested product.

8. The method of claim 1 further comprising the step of the server sending to the mobile device a store identification signal that allows the mobile device to identify the identity and location of the physical store.

9. The method of claim 1 wherein the server is capable of sending a warning signal to the mobile device if the selected product is already paid for.

10. The method of claim 1 further comprising the steps of:
receiving at the server a log-in signal sent from the mobile device, and
associating the mobile device with a customer account.

11. The method of claim 10 wherein the customer account is associated with one or more coupons.

12. The method of claim 10 wherein the customer account is associated with a shopping list comprising of one or more products, the method further comprising the step of sending to the mobile device a map signal that allows the mobile device to display the location of one or more products on the shopping list.

13. The method of claim 10 wherein the customer account is associated with a wish list comprising of one or more products, the method further comprising the step of sending to the mobile device a map signal that allows the mobile device to display the location of one or more products on the wish list.

14. The method of claim 10 further comprising the step of reserving the selected product for a particular customer.

15. The method of claim 10 further comprising the steps of:
selecting one or more suggested products based in part on the customer account, and
the server sending to the mobile device a suggested product signal that allows a user to view information about one or more suggested products.

16. The method of claim 10 wherein the customer account is associated with a customer loyalty program.

17. A server for enabling electronic purchasing within a physical store comprising:
a payment processing module, adapted to communicate with a payment gateway, for processing payments;
a shopping cart module for maintaining a virtual shopping cart;
a mobile device communications module, adapted to communicate with a mobile device, for receiving product and payment information from a mobile device;
a merchant store system module, adapted to communicate with a merchant store system, for receiving product information from a merchant store system; and
a store security system module, adapted to facilitate communication between the merchant store system and a store security system, for identifying a product that has recently been purchased.

18. The server of claim 17 wherein the merchant store system module is adapted to receive an inventory signal sent by the merchant store system.

19. The server of claim 18 wherein the inventory signal comprises product location information.

20. The server of claim 17 wherein the mobile device communications module is adapted to send to the mobile device a product description signal that allows the mobile device to display information about a product.

21. The server of claim 17 wherein the mobile device communications module is adapted to send to the mobile device a receipt signal that allows the mobile device to display a receipt.

22. The server of claim 17 wherein the mobile device communications module is adapted to receive a coupon signal sent from the mobile device.

23. The server of claim 17 wherein the mobile device communications module is adapted to send to the mobile device a map signal that allows the mobile device to display the location of one or more products of interest.

24. The server of claim 23 wherein the mobile device communications module is further adapted to receive a product location request signal from the mobile device and select the one or more products of interest using the product location request signal.

25. The server of claim 17 wherein the mobile device communications module is adapted to send a suggested product signal to the mobile device that allows the mobile device to display information about a suggested product.

26. The server of claim 17 wherein the merchant store system module is adapted to receive a store information signal from the merchant store system that indicates the identity and location of the physical store, and the mobile device communications module is adapted to send a store identification signal to the mobile device that allows the mobile device to identify the identity and location of the physical store.

27. The server of claim 17 wherein the mobile device communications module is capable of sending a warning signal to the mobile device if a selected product is already paid for.

28. The server of claim 17 wherein the mobile device communications module is adapted to:
receive a log-in signal sent from the mobile device, and
associate the mobile device with a customer account.

29. The server of claim 28 wherein the customer account is associated with one or more coupons.

30. The server of claim 28 wherein the customer account is associated with a shopping list comprising one or more products, the mobile device communications module further adapted to send to the mobile device a map signal that allows the mobile device to display the location of one or more products on the shopping list.

31. The server of claim 28 wherein the customer account is associated with a wish list comprising one or more products, the mobile device communications module further adapted to send to the mobile device a map signal that allows the mobile device to display the location of one or more products on the wish list.

32. The server of claim 28 wherein the server is adapted to reserve a product for a particular customer.

33. The server of claim 28 wherein the server is adapted to select one or more suggested products based on the customer account and the mobile device communications module is adapted to send a suggested product signal to the mobile device that allows the mobile device to display information about one or more suggested products.

34. The server of claim 28 wherein the customer account is associated with a customer loyalty program.

35. A server for enabling electronic purchasing within a physical store using software modules, comprising:
a payment processing module, adapted to communicate with a payment gateway, for processing payments;
a shopping cart module for maintaining a virtual shopping cart;
a mobile device communications module, adapted to communicate with a mobile device, for receiving product and payment information from a mobile device;
a merchant enterprise system module, adapted to communicate with a merchant enterprise system, for exchanging product information between the server and the merchant enterprise system, the merchant enterprise system capable of receiving information from a merchant store system about a product located within a particular store; and
a store security system module, adapted to facilitate communication between the merchant store system and a store security system, for identifying a product that has recently been purchased.

36. The server of claim 35 wherein each merchant store system contains an inventory of products.

37. The server of claim 36 wherein the inventory of products contains product location information.

38. The server of claim 35 wherein the mobile device communications module is adapted to send to the mobile device a product description signal that allows the mobile device to display information about a product.

39. The server of claim 35 wherein the mobile device communications module is adapted to send to the mobile device a receipt signal that allows the mobile device to display a receipt.

40. The server of claim 35 wherein the mobile device communications module is adapted to receive a coupon signal sent from the mobile device.

41. The server of claim 35 wherein the mobile device communications module is adapted to send to the mobile device a map signal that allows the mobile device to display the location of one or more products of interest.

42. The server of claim 41 wherein the mobile device communications module is further adapted to receive a product location request signal from the mobile device and select the one or more products of interest using the product location request signal.

43. The server of claim 35 wherein the mobile device communications module is adapted to send a suggested product signal to the mobile device that allows the mobile device to display information about a suggested product.

44. The server of claim 35 wherein the merchant enterprise system module is adapted to receive a store information signal from the merchant enterprise system that indicates the identity and location of the physical store, and the mobile device communications module is adapted to send a store identification signal to the mobile device that allows the mobile device to identify the identity and location of the physical store.

45. The server of claim 35 wherein the mobile device communications module is capable of sending a warning signal to the mobile device if a selected product is already paid for.

46. The server of claim 35 wherein the mobile device communications module is adapted to:
receive a log-in signal sent from the mobile device, and
associate the mobile device with a customer account.

47. The server of claim 46 wherein the customer account is associated with one or more coupons.

48. The server of claim 46 wherein the customer account is associated with a shopping list comprising one or more products, the mobile device communications module further adapted to send to the mobile device a map signal that allows the mobile device to display the location of one or more products on the shopping list.

49. The server of claim 46 wherein the customer account is associated with a wish list comprising one or more products, the mobile device communications module further adapted to send to the mobile device a map signal that allows the mobile device to display the location of one or more products on the wish list.

50. The server of claim 46 wherein the server is adapted to reserve a product for a particular customer.

51. The server of claim 46 wherein the server is adapted to select one or more suggested products based on the customer account and the mobile device communications module is adapted to send a suggested product signal to the mobile device that allows the mobile device to display information about one or more suggested products.

52. The server of claim 46 wherein the customer account is associated with a customer loyalty program.
